(19) United States
(12) Patent Application Publication
(10) Pub. No.: US 2012/0187272 A1
(43) Pub. Date: Jul. 26, 2012

(54) Wheeled Collapsible Stand for a Power Driven Machine

(75) Inventor: Jackie Lee, Taichung (TW)

(73) Assignee: P & F Brother Industrial Corporation, Taichung (TW)

(21) Appl. No.: 13/014,652

(22) Filed: Jan. 26, 2011

(51) Int. Cl. F16M 3/00

(52) U.S. Cl. 248/647

(57) ABSTRACT

A wheeled collapsible stand for a machine includes first and second frames pivotally connected to each other, a wheel unit mounted on a fulcrum region of the first frame, and a tabletop bracing member pivotally mounted on a pivoted end of the second frame and a weight end of the first frame for supporting the machine thereon. When the weight end is lifted by forcing a power end, the pivoted end is turned and lifted while a foot end of the second frame is lowered to rest on the ground so as to permit the tabletop bracing member to be displaced to a working position.

### BACKGROUND OF THE INVENTION

1. Field of the Invention

This invention relates to a wheeled collapsible stand for a power driven machine, more particularly to a wheeled collapsible stand that provides support for a portable power driven machine, such as a circular sawing machine, and that is collapsible conveniently.

2. Description of the Related Art

Referring to FIG. 1, a conventional stand 10 is shown to include a tabletop 11 for supporting a portable cutting machine 12, and a base frame 13 disposed under the tabletop 11. The tabletop 11 has a plurality of insert grooves 111 for engaging upper ends of the base frame 13. The base frame 13 has first and second frames 131, 132 pivotally connected to each other. Two wheels 133 are mounted on lower ends of the first frame 131 for rollably supporting the base frame 13 on the ground. The base frame 13 is unfolded for supporting the tabletop 11 at a working position, and is folded to permit the wheels 133 to roll on the ground for transportation. Such a rickety structure of the base frame 13, plus the simple connection between the insert grooves 111 and the upper ends of the base frame 13, renders the conventional stand 10 unfit for supporting the cutting machine 12 which is power driven and which thus requires a very steady working condition.

Referring to FIG. 2, another conventional stand 20 has a support 21 for supporting a tabletop (not shown), a first frame 22, a second frame 23, and a pair of linking shafts 24. The first frame 22 is pivotally connected to the support 21, and has opposite handgrip and foot ends 221, 222, and an intermediate portion pivotally connected to the second frame 23. The second frame 23 is coupled to the support 21 through the linking shafts 24 so as to permit folding and unfolding the first and second frames 22, 23. However, in order to successfully fold or unfold the frames 22, 23, the user has to keep holding up the support 21 during the folding or unfolding operation. It would be a hard task to lift up the support 21 for the operation, particularly when there is a bulky machine mounted thereon.

### SUMMARY OF THE INVENTION

An object of the present invention is to provide a wheeled collapsible stand for a machine which can be folded and unfolded conveniently with less effort.

According to this invention, the wheeled collapsible stand includes a wheel unit, a first frame having a fulcrum region on which the wheel unit is rotatably mounted, a power end disposed forwardly of the fulcrum region, a weight arm extending from the fulcrum region, and a weight end telescopically extendible relative to the weight arm, a second frame having a foot end and a pivoted end opposite to each other, and an intermediate portion pivotally connected to the weight arm such that the pivoted end is disposed forwardly of the weight end of the first frame while the foot end is disposed rearwardly of the power end of the first frame, and a tabletop bracing member having a front end pivotally mounted on the pivoted end of the second frame, and a rear end pivotally mounted on the weight end of the first frame.

When the weight end is lifted and is telescopically extended by virtue of a lifting force applied to the rear end, the rear end is simultaneously moved incrementally from a collapsed position, where the rear end is proximate to the foot end of the second frame, to a working position, where the rear end is distal from the foot end of the second frame, thereby resulting in an incremental increase in height of the rear end and enabling the rear end to be constantly kept in a horizontal position relative to the front end.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a conventional wheeled collapsible stand;

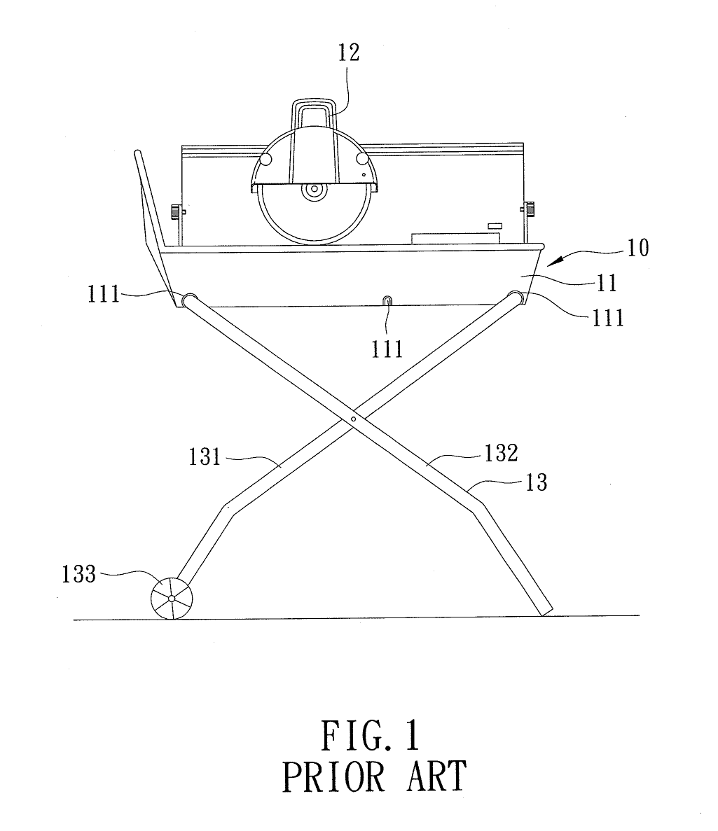

FIG. 2 is a schematic view of another conventional wheeled collapsible stand;

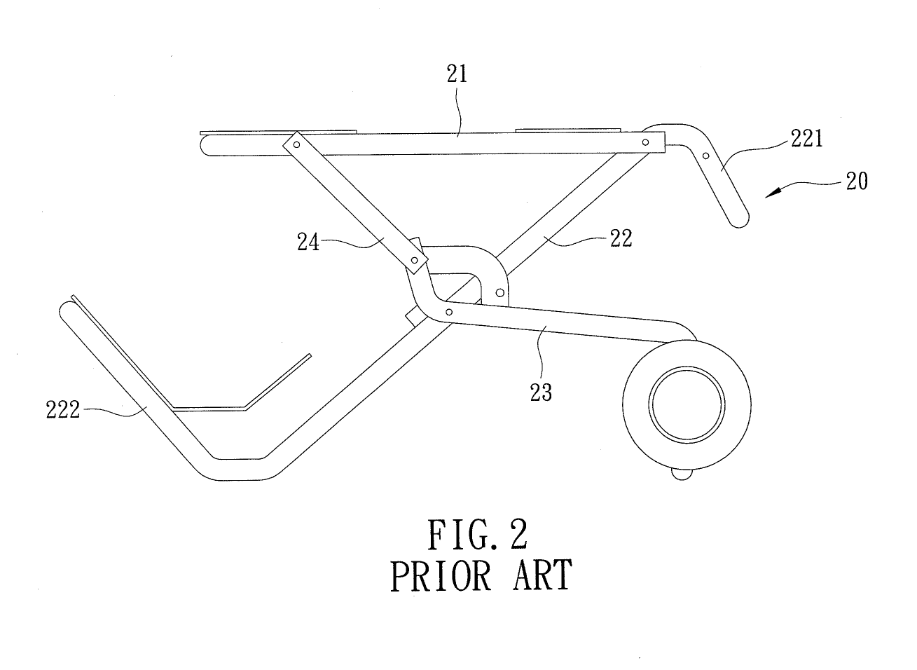

FIG. 3 is a perspective view of the first preferred embodiment of a wheeled collapsible stand according to this invention when unfolded;

FIG. 4 is a side view of the first preferred embodiment when unfolded;

FIG. 5 is a top view of the first preferred embodiment when unfolded;

FIG. 6 is a partly sectioned side view of the first preferred embodiment when unfolded, taken along line VI-VI of FIG. 5;

FIG. 7 is a perspective view of the first preferred embodiment when folded;

FIG. 8 is a side view of the first preferred embodiment when folded;

FIG. 9 is a top view of the first preferred embodiment when folded;

FIG. 10 is a partly sectioned view when a locking unit is in a latched position, taken along line X-X of FIG. 9;

FIG. 11 is a fragmentary enlarged view of FIG. 10;

FIG. 12 is a top view showing the locking unit in an unlatched position;

FIG. 13 is a fragmentary enlarged view of the locking unit in the unlatched position;

FIG. 14 is a schematic view showing the first preferred embodiment in transportation;

FIG. 15 is a side view of the second preferred embodiment of a wheeled collapsible stand according to this invention when folded; and

FIG. 16 is a schematic view showing the second preferred embodiment in transportation.

### DETAILED DESCRIPTION OF THE PREFERRED EMBODIMENTS

Before the present invention is described in greater detail, it should be noted that same reference numerals have been used to denote like elements throughout the specification.

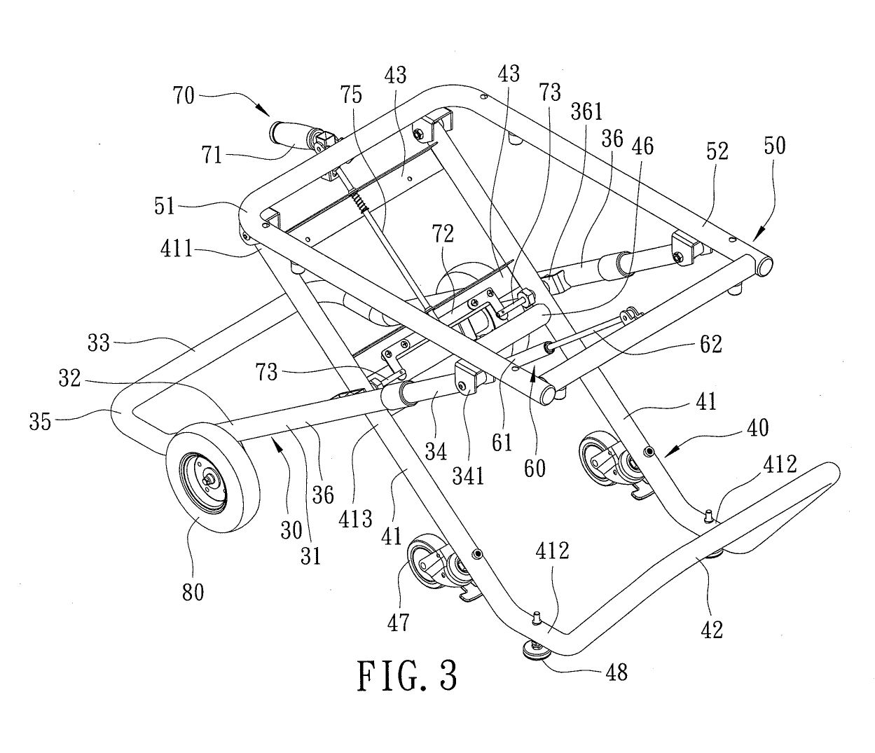

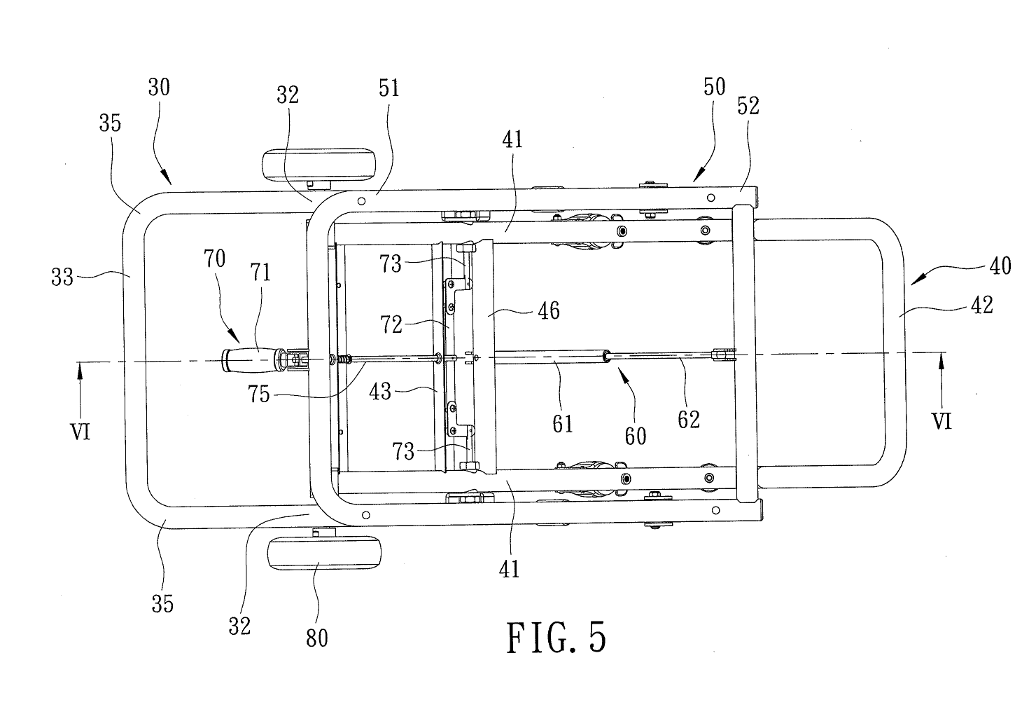

Referring to FIGS. 3 to 6, the first preferred embodiment of a wheeled collapsible stand according to the present invention is shown to comprise a wheel unit 80, a first frame 30, a second frame 40, a tabletop bracing member 50, an extendible lifting unit 60, and a locking unit 70.

The wheel unit 80 includes two wheels.

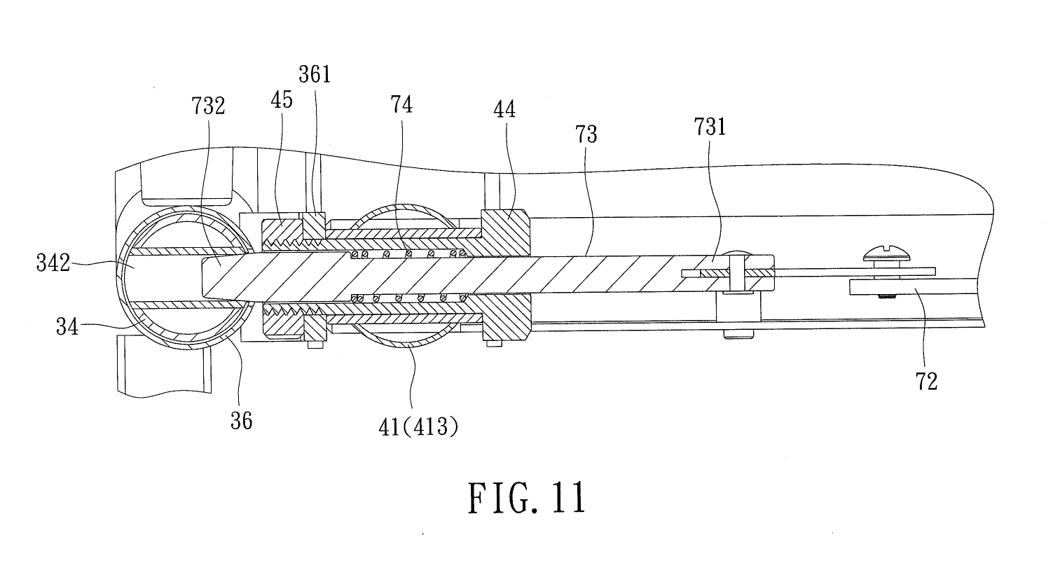

The first frame 30 includes two parallel outer tubular bodies 31, two parallel inner tubular bodies 34, and a tread portion 33. Each of the outer tubular bodies 31 has a fulcrum regions 32 on which a respective one of the wheels is rotatably mounted about a fulcrum axis, a power end 35 disposed forwardly of the fulcrum region 32, a weight arm 36 extending from the fulcrum region 32 in a first lengthwise direction, and a spacer lug 361 mounted on the weight arm 36. Each of the inner tubular bodies 34 is telescopically fitted in the weight arm 36 of the respective one of the outer tubular bodies 31, and extends to terminate at a weight end 341. Hence, the weight end 341 is telescopically extendible relative to the weight arm 36 such that, when the power end 35 is forced to turn the weight end 341 from a first laid-down position to a first upwardly inclined position, the weight end 341 is extendible from a retracted position to an extended position. The tread portion 33 extends from and is transverse to the power ends 35 such that a treading force applying thereto results in lifting of each weight end 341 to the first upwardly inclined position. Moreover, as shown in FIG. 11, an insert portion of each of the inner tubular bodies 34 fitted in the respective outer tubular body 31 has two latched holes 342 that extend therethrough and that are spaced apart from each other along the first lengthwise direction.

The second frame 40 includes two parallel rod portions 41 and a handgrip portion 42. Each of the rod portions 41 has a foot end 412 provided with a supporting stud 48, a pivoted end 411 opposite to the foot end 412 in a second lengthwise direction, and an intermediate portion 413 which is pivotally connected to the respective weight arm 36 by virtue of a hollow pivot 44 that extends in the spacer lug 361 along a linking axis parallel to the fulcrum axis and is engaged with a screw nut 45 (see FIG. 11). Thus, the pivoted end 411 is disposed forwardly of the respective weight end 341 while the foot end 412 is disposed rearwardly of the respective power end 35. When the weight end 341 is lifted from the first laid-down position to the first upwardly inclined position, the pivoted end 411 is turned about the linking axis from a second laid-down position to a second upwardly inclined position while the foot end 412 is lowered from a suspended position to a rest position, where the supporting stud 48 of the foot end 412 is adapted to rest on the ground. The handgrip portion 42 extends rearwardly from the foot ends 412 and is transverse to the second lengthwise direction. Additionally, a plurality of crosspieces 43, 46 are disposed to extend between the rod portions 41 proximate to the pivoted ends 411 and the intermediate portions 413. A caster unit 47 includes two casters respectively mounted on the intermediate portions 413 adjacent to the foot ends 412.

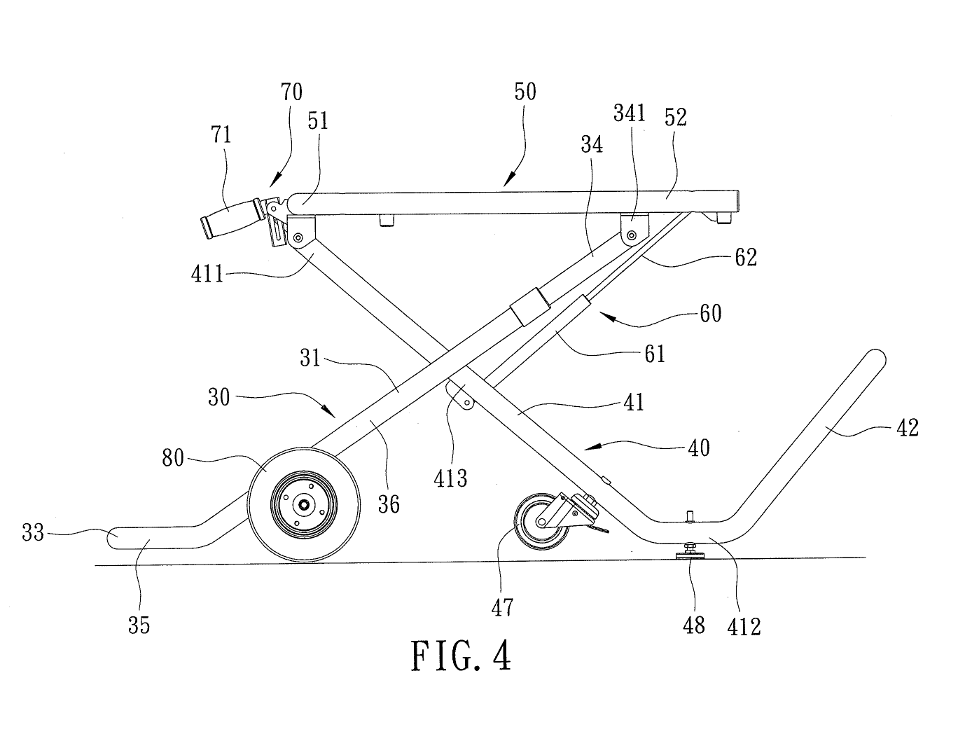

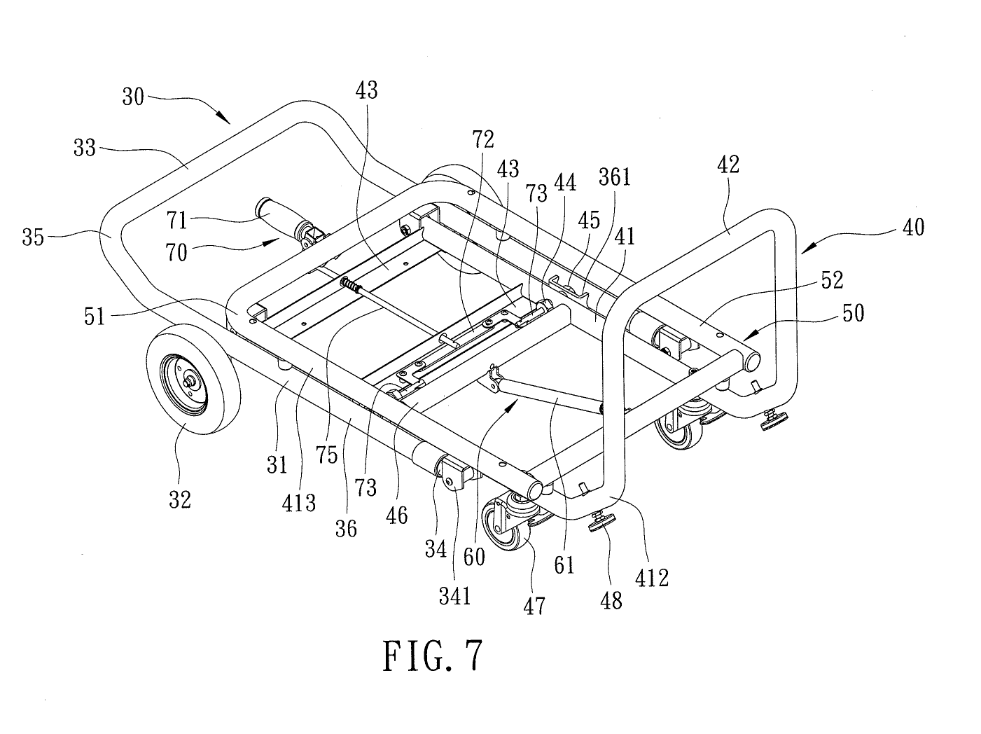

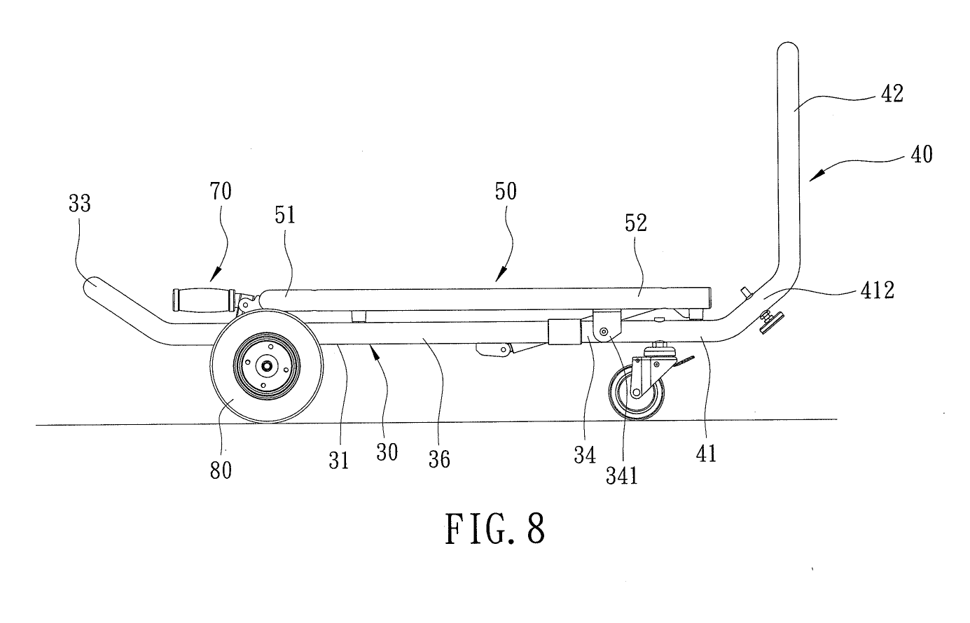

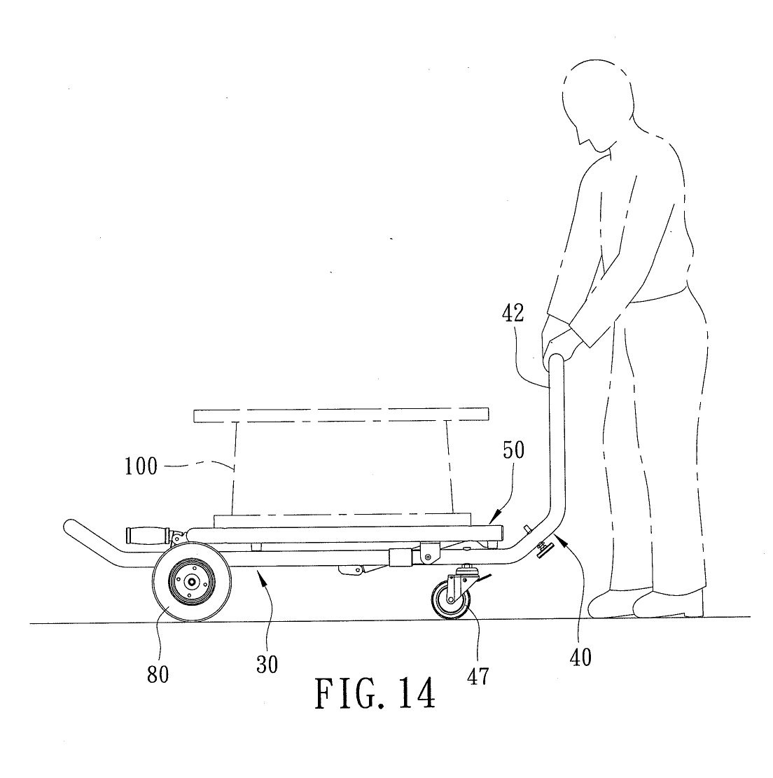

The tabletop bracing member 50 is rectangular in shape, is disposed for supporting a power driven machine 100 (see FIG. 14), and has a front end 51 pivotally mounted on the pivoted ends 411 about a front axis parallel to the linking axis, and a rear end 52 pivotally mounted on the weight ends 341 about a rear axis parallel to the linking axis. When a lifting force is applied to the rear end 52, the rear end 52 is lifted gradually upward from a collapsed position (as shown in FIGS. 7 and 8), where the rear end 52 is proximate to the foot ends 412, to a working position, as shown in FIGS. 3 and 4, where the rear end 52 is distal from the foot ends 412. During the gradual lifting movement of the rear end 52, the weight ends 341 are lifted from the first laid-down position to the first upwardly inclined position and are telescopically extended incrementally in the first lengthwise direction. The lifting movement of the rear end 52 from the collapsed position to the working position results in synchronous telescopic extension of the weight ends 341 therewith in the lengthwise direction, and a horizontal component generated as a result of the telescopic extension is passed onto the rear end 52 to thereby constantly keep the rear end 52 on a level with the front end 51 during the lifting movement.

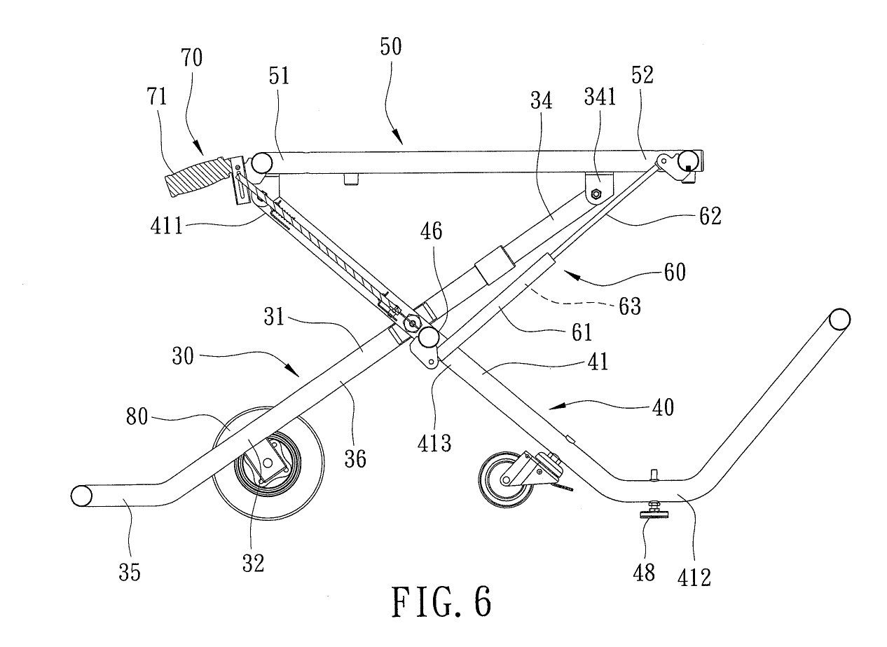

Referring to FIG. 6, in this embodiment, the extendible lifting unit 60 includes a hydraulic cylinder 61 pivotally connected to the crosspiece 46 on the intermediate portions 413 of the second frame 40, a piston 63 which is disposed in and is sealingly slidable relative to the hydraulic cylinder 61, and a plunger 62 disposed to connect the piston 63 to the rear end 52 of the tabletop bracing member 50, thereby providing a buffer during lowering of the tabletop bracing member 50, and a lift during lifting of the tabletop bracing member 50.

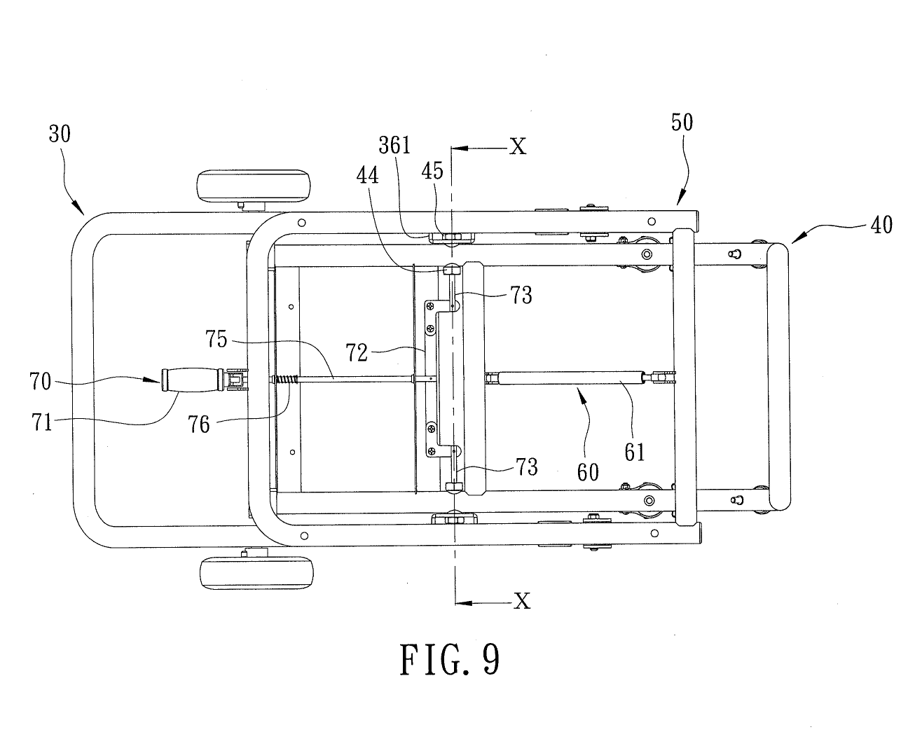

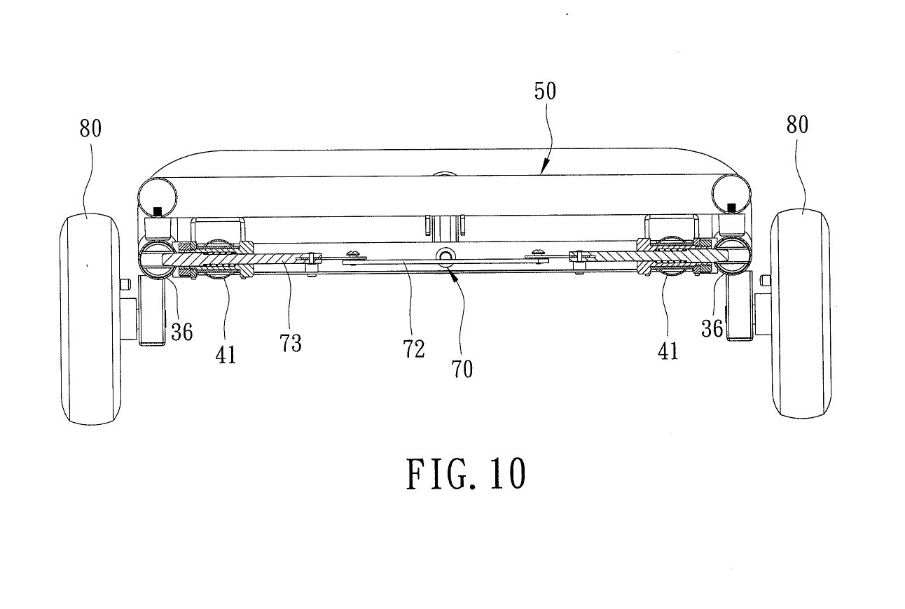

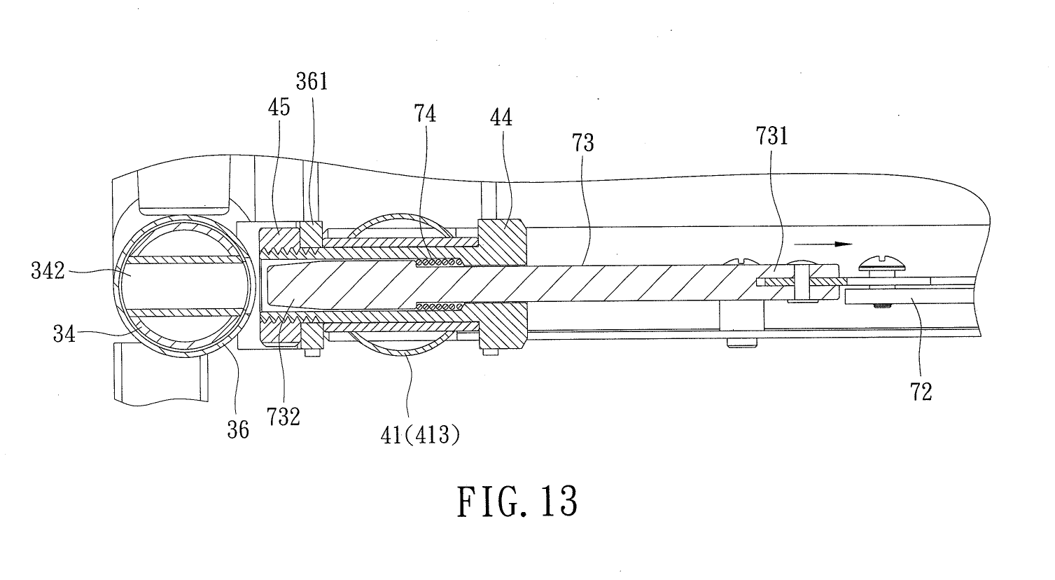

Referring to FIGS. 9 to 11, the locking unit 70 has two latch members 73 and two biasing members 74. Each of the latch members 73 has a latching end 732 which extends through the respective pivot 44 and which is movable relative to the respective intermediate portion 413 along the linking axis between a latched position, as shown in FIG. 11, where the latching end 732 extends beyond the intermediate portion 413 and is engaged in the corresponding latched hole 342 when the weight ends 341 are in one of the extended and retracted positions, thereby preventing the rear end 52 of the tabletop bracing member 50 from moving away from one of the working and collapsed positions, and an unlatched position, as shown in FIG. 13, where the latching end 732 is disengaged from the latched hole 342, and an actuated end 731 disposed opposite to the latching end 732 relative to the intermediate portion 413. Each of the biasing members 74 is sleeved on the respective latch member 73 to bias the latching end 732 to the latched position. The locking unit 70 further has an actuator rod 75 which is movable relative to the crosspieces 43 of the second frame 40 in the second lengthwise direction, and which has a rear rod end coupled to the actuated ends 731 of the latch members 73 by means of a linkage 72 so as to synchronously pull the latching ends 732 from the latched position to the unlatched position against the biasing action of the biasing members 74, and a front rod end extending forwardly of the pivoted end 411 and provided with a cammed handle 71 for manual operation, and a biasing member 76 disposed to bias the actuator rod 75 to a non-actuated position.

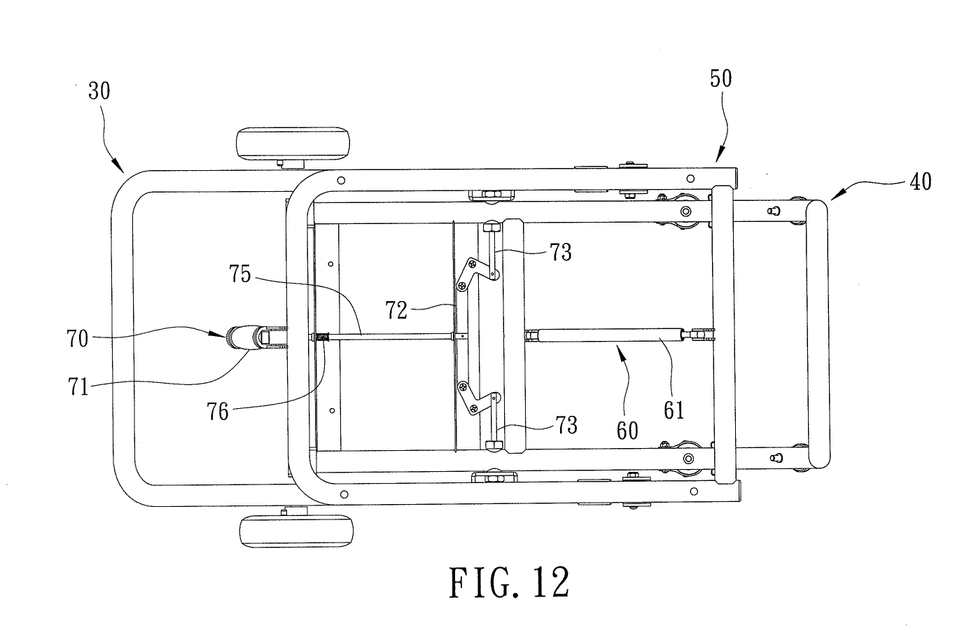

Referring to FIGS. 12 and 13, when it is desired to fold the stand of the present invention, the cammed handle 71 is operated to move the actuator rod 75 so as to pull the latch members 73 to the unlatched position. Referring again to FIGS. 7 and 8, by virtue of the mass of the tabletop bracing member 50 and by virtue of the buffer provided by the extendible lifting unit 60, the tabletop bracing member 50 can be moved gradually to the collapsed position. Meanwhile, the foot ends 412 of the second frame 40 are displaced to the suspended position so as to bring the caster unit 47 to roll on the ground while the handgrip portion 42 is moved further upwards so as to facilitate manual steering of the stand.

Accordingly, during folding and unfolding of the stand, with the arrangement of the first frame 30 including telescopically fitting outer and inner tubular bodies 31, 34, the tabletop bracing member 50 can be kept horizontal and moved gradually by damping and lifting of the extendible lifting unit 60, thereby enabling the user to fold and unfold the stand with safety and less effort. Besides, by treading of the tread portion 33, the weight ends 341 of the first frame 30 can be lifted easily to bring the pivoted ends 411 of the second frame 40 to the upwardly inclined positions, thereby effortlessly placing the stand in the working position.

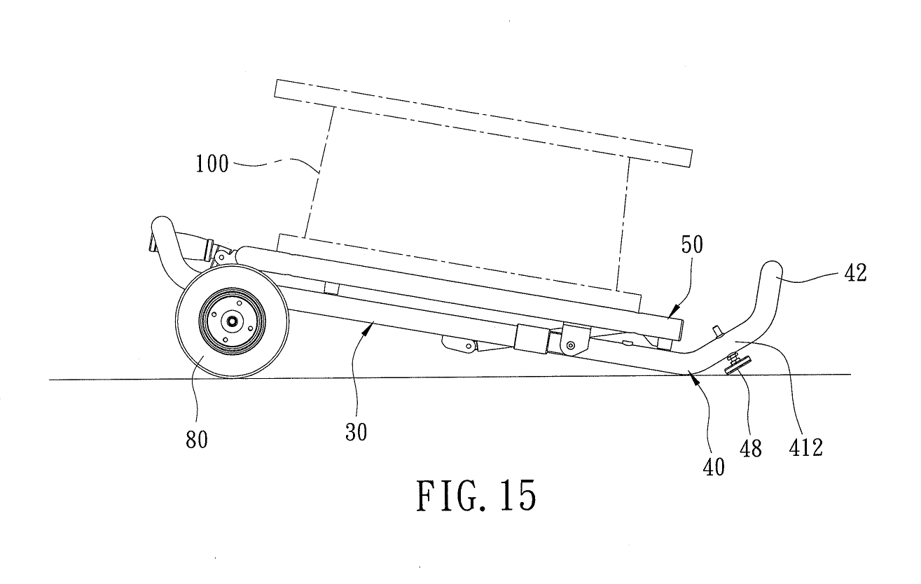

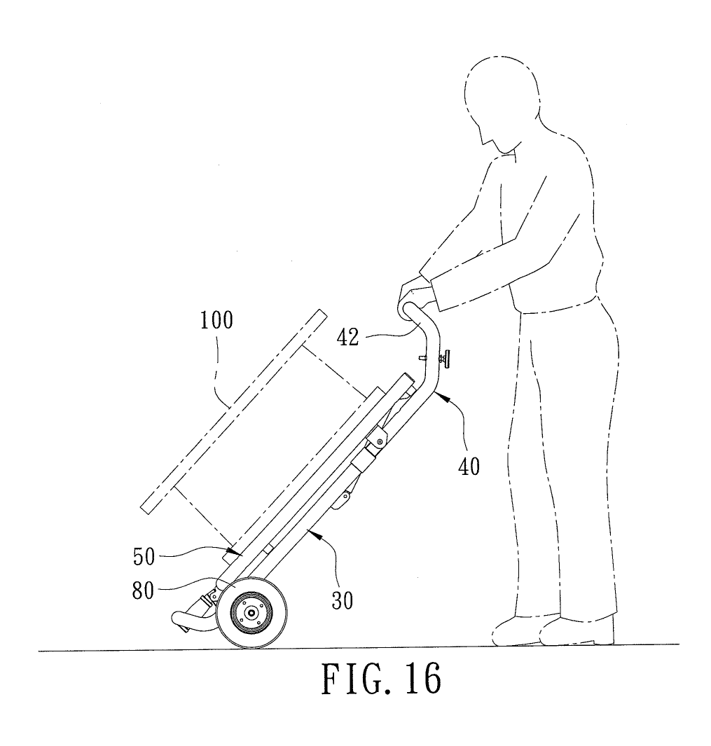

Referring to FIGS. 15 and 16, the second preferred embodiment of a wheeled collapsible stand according to this invention is shown to be similar to the first preferred embodiment in construction, except that the caster unit is dispensed therewith, and the handgrip portion 42 of the second frame 40 is shorter. Thus, when the stand is folded, the user can lift the handgrip portion 42 for wheeled transportation.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A wheeled collapsible stand for a machine comprising:
a wheel unit;
a first frame having a fulcrum region on which said wheel unit is rotatably mounted about a fulcrum axis, a power end disposed forwardly of said fulcrum region, a weight arm extending from said fulcrum region in a first lengthwise direction, and a weight end which is telescopically extendible relative to said weight arm such that, when said power end is forced to turn said weight end from a first laid-down position to a first upwardly inclined position, said weight end is extendible from a retracted position to an extended position;
a second frame having a foot end and a pivoted end opposite to each other in a second lengthwise direction, and an intermediate portion which is pivotally connected to said weight arm about a linking axis parallel to the fulcrum axis such that said pivoted end is disposed forwardly of said weight end of said first frame while said foot end is disposed rearwardly of said power end of said first frame, and such that, when said weight end is lifted from the first laid-down position to the first upwardly inclined position, said pivoted end is turned about the linking axis from a second laid-down position to a second upwardly inclined position while said foot end is lowered from a suspended position to a rest position, where said foot end is adapted to rest on the ground; and
a tabletop bracing member having a front end which is pivotally mounted on said pivoted end of said second frame about a front axis parallel to the linking axis, and a rear end which is pivotally mounted on said weight end about a rear axis parallel to the linking axis such that, when said weight end is lifted from the first laid-down position to the first upwardly inclined position and is telescopically extended in the first lengthwise direction by virtue of a lifting force applied to said rear end, said rear end is simultaneously moved incrementally from a collapsed position, where said rear end is proximate to said foot end of said second frame, to a working position, where said rear end is distal from said foot end of said second frame, thereby resulting in an incremental increase in height of said rear end and enabling said rear end to be constantly kept in a horizontal position relative to said front end.

2. The wheeled collapsible stand according to claim 1, further comprising an extendible lifting unit disposed to apply the pulling force on said rear end.

3. The wheeled collapsible stand according to claim 2, wherein said extendible lifting unit includes a hydraulic cylinder pivotally connected to one of said intermediate portion of said second frame and said rear end of said tabletop bracing member, a piston which is disposed in and sealingly slidable relative to said hydraulic cylinder, and a plunger disposed to connect said piston to the other one of said intermediate portion of said second frame and said rear end of said tabletop bracing member.

4. The wheeled collapsible stand according to claim 1, further comprising a caster unit mounted on said intermediate portion of said second frame and configured such that, when said foot end is in the suspended position, said caster unit is brought to roll on the ground.

5. The wheeled collapsible stand according to claim 1, wherein said first frame has a tread portion which extends from and transverse to said power end such that a treading force applying thereon results in lifting of said weight end to the first upwardly inclined position.

6. The wheeled collapsible stand according to claim 1, wherein said second frame has a handgrip portion which extends rearwardly from said foot end and transverse to the second lengthwise direction for gripping when said rear end of said tabletop bracing member is displaced to the collapsed position for wheeled transportation.

7. The wheeled collapsible stand according to claim 1, further comprising a locking unit disposed to prevent said rear end of said tabletop bracing member from moving away from one of the working and collapsed positions.

8. The wheeled collapsible stand according to claim 7, wherein said first frame includes an inner tubular body which is telescopically fitted in said weight arm and which extends to terminate at said weight end, said inner tubular body having a latched hole which extends therethrough along the linking axis, said locking unit having a latch member having a latching end which is disposed to be movable through and relative to said intermediate portion of said second frame along the linking axis between a latched position, where said latching end extends beyond said intermediate portion and is engaged in said latched hole when said weight end is in one of the extended and retracted positions, and an unlatched position, where said latching end is disengaged from said latched hole, and a biasing member disposed to bias said latching end to the latched position.

9. The wheeled collapsible stand according to claim 8, wherein said latch member has an actuated end disposed opposite to said latching end relative to said intermediate portion of said second frame, said locking unit having an actuator rod which is movable relative to said second frame in the second lengthwise direction, and which has a rear rod end coupled to said actuated end of said latch member so as to pull said latching end from the latched position to the unlatched position against biasing action of said biasing member, and a front rod end that extends forwardly of said pivoted end for manual operation.
